(19) United States
(12) Patent Application Publication
(10) Pub. No.: US 2012/0062733 A1
(43) Pub. Date: Mar. 15, 2012

(54) SMART TARGET SURVEILLANCE SYSTEM

(76) Inventors: Sergei Y. Mironichev, Moscow (RU); Christopher D. Mechling, San Diego, CA (US)

(21) Appl. No.: 13/009,506

(22) Filed: Jan. 19, 2011

Related U.S. Application Data
(60) Provisional application No. 61/296,262, filed on Jan. 19, 2010.

(51) Int. Cl. H04N 7/18

(52) U.S. Cl. 348/143; 348/E07.085

(57) ABSTRACT

A surveillance system comprising a remote video server, a camera, a data receiving and processing server and a computer device is disclosed herein. The camera captures video and sends the video to the remote video server. The remote video server wirelessly transmits the video to the data receiving and processing server for video processing. The computer device may then securely and wirelessly connect to the data receiving and processing server to view the video.

### PRIORITY CLAIM

This utility patent application contains subject matter claiming benefit of the priority date of U.S. Provisional Patent Application Ser. No. 61/296,262, filed on Jan. 19, 2010, entitled “Smart Target Surveillance System.” Accordingly, the entire contents of this provisional patent application are hereby expressly incorporated by reference.

### FIELD OF THE INVENTION

The present invention relates generally to devices capable of remote video and audio surveillance. More particularly, the present invention relates to system and methods providing portable monitoring, recording and transmitting digital information wirelessly across long distances.

### BACKGROUND OF THE INVENTION

Surveillance and monitoring systems have played a valuable role in many contexts. For example, surveillance video cameras are well renowned for capturing images of criminal activity within various financial and commercial institutions. Video cameras have also played an increasingly valuable role in less visible contexts. For example, video cameras are increasingly being used to monitor work environments to ensure productivity or compliance with operating procedures. Additionally, video cameras are also valuable in providing evidence that establishes the nonoccurrence of events in insurance fraud cases. Surveillance systems have long been utilized by law enforcement and military personnel in a wide array of applications.

In many of these systems, one or more television cameras and microphones are positioned to observe an area to be monitored. Sensors which initiate various activities within the system are connected by electric cables to a remotely located command post such as a guard or police station. The cameras often have several controllable functions such as variable lens aperture, focus and zoom. Optionally, they may be mounted on motorized pan and tilt translators, enabling a broadening ability to capture additional information. Other surveillance systems have avoided the limitations of a cable connection between the sensors and the command station by using a radio-frequency communication link of some kind.

U.S. Pat. No. 4,511,886 discloses a surveillance system in which sensors are linked by coaxial cable to a central station for further processing. A plurality of video cameras and microphones are provided for monitoring a number of locations such as cash register positions. The outputs of the sensors are sampled sequentially by a video switcher and converted to compressed, single sideband signals to conserve the bandwidth required of the coaxial cable. Coding information is included in the transmitted signals for identifying which of the plural sensors is activated and unauthorized interception of the signals is prevented by randomly varying the frequency of the signal carrier.

U.S. Pat. No. 4,326,221 is another surveillance system described in the prior art in which a plurality of audio-video sensors are linked to a central station through a radio frequency transceiver. The sensors are individually addressed and controlled in response to a series of tones by which the lens aperture, focus and zoom settings of the cameras are operated. Signals received at a central station are recorded and displayed as desired and the central station may be activated by an intrusion sensor at a remote location. Since the sensors and central station are not linked by a cable, either or both may be mobile.

The surveillance systems described above are intended for permanent installations in which considerations of physical size, power consumption and reliability are of limited importance. In many security applications, these variables become of critical importance. The monitoring and protection of commercial aircraft is one such application where the size, weight, power and reliability of the airborne components of the surveillance system are all of special concern. Also, neither of the systems already described is directed to providing security for the surveillance system itself or for the command signals transmitted to the sensors by the monitoring station. Further, it is often important that the surveillance system should not be visible to personnel in or around the area being monitored; and that the system should be easily installed within an existing facility with a minimal amount of disruption. To prevent unauthorized activation of the system or interception of the surveillance information, it is also desirable that the command signals and sensor signals be encrypted. Finally, nothing disclosed in the prior art teaches remote surveillance systems being controlled by software with the expanded potential of using multiple server-based units for audio/video and data processing for the transmitted information. Thus, there exists a need in the art to develop a technology suitable for addressing all of the limitations described supra.

Therefore, it is an object of the present invention to provide a system comprising a camera capable of recording video, a remote video server and a data receiving and processing server, wherein the system is powered by an external power source and controlled by software via a computer processor. It is an additional object of the present invention to provide the system described above in a non-stationary manner. It is a further object of the present invention to provide a plurality of cameras capable of recording video as determined by a desired image resolution variable and frame rate variable, wherein each variable is adjusted by the software via a computer processor. It is still further an object of the present invention to provide a system equipped with a camera having an appropriate lens based on environmental variables. It is still further an object of the present invention to provide a system as described above, wherein all data is transmitted and received wirelessly over a distance of greater than 1 kilometer. It is yet a further object of the present invention to provide and receive data transmission wirelessly under encryption. In a most preferred embodiment, the data is transmitted and received wirelessly under encryption and accessed in real time.

### SUMMARY OF THE INVENTION

The invention can be better visualized by turning now to the following drawings wherein like elements are referenced by like numerals. In accordance with the invention, the problem of an unsecured, permanently installed surveillance system is avoided by having a remote video server and data receiving and processing server that are portable and capable of transmitting video data over an encrypted signal.

In a first aspect of the invention, the invention is directed to a method for providing remote surveillance to a target area comprising the steps of: providing a remote video server portably to the target area, providing a camera in surveillance of the target area, transmitting video data to a portable data receiving and processing server, processing said video data and accessing the video data locally or remotely on a computer device.

The target area may be, but is not limited to, a construction area, a remote rural area or some other area in which permanent surveillance may not be necessary. The remote video server is controlled by a computer device, which can be accessed by a user either on-site or from a remote location. The camera transmits video data to the remote video server which, in turn, transmits video data to the data receiving and processing server.

In a second aspect of the invention, the invention is directed to a system for providing remote surveillance to a target area having a remote video server portably placed in the target area, a camera in surveillance of the target area capturing video data, a portable data receiving and processing server configured to receive video data and a computer device configured to communicate with the data receiving and processing server.

In a third aspect of the invention, the invention is directed to a remote surveillance kit comprising a server, a rod configured for transmitting video data and a support stand. In one embodiment, the remote surveillance kit includes a camera to capture video data. The video data is then transmitted to the server, which then transmits the video data via the rod. In another embodiment, the server receives and processes video data from an external source by receiving the video data via the rod. The remote surveillance kit would include an additional antenna configured to communicate with a computer device.

The remote video server is movably placed in the target area and is not rigidly fixed to a particular location. The camera transmits video data to the remote video server which, in turn, transmits video data to the data receiving and processing server. The camera may be activated by detecting motion with a motion sensor. The camera can be, but is not limited to, a standard video camera, a high definition camera, an infrared camera, a thermal camera or a 3D camera.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic illustration of a first preferred embodiment of the system;

FIG. 2 is a block diagram generally describing transfer of video data through the system.

FIG. 3 is a perspective view of the RVS unit;

FIG. 4 is a top plan view of the RVS unit;

FIG. 5 is a perspective view of the stand supporting the RVS unit; and

FIG. 6 is a perspective view of a remote surveillance kit containing components for constructing the RVS unit.

### DESCRIPTION OF THE PREFERRED EMBODIMENTS

As depicted in FIG. 1, the basic components of a portable surveillance system 10 are illustrated schematically. Initially, the remote video server (RVS) unit 20 collects video data from its connected array of cameras 23 and transmits to the data receiving and processing server (DRPS) unit 30. Once the video data is received and processed, it may be accessed using software operated on a computer processor 40 (i.e., laptop or desktop computer). The RVS unit 20 and DRPS unit 30 are capable of extreme mobility and may be positioned according to specific surveillance requirements. The RVS unit 20 and DRPS unit 30 are capable of receiving and transmitting data for ultimate processing by a user.

The RVS unit 20 may be connected to the camera 23. Optionally, there may be a plurality of cameras 23 connected to a single RVS unit 20 for ultimately processing data to a single DRPS unit 30. Alternatively, specific cameras 23 may be used for specific surveillance circumstances. For instance, cameras capable of recording three dimensional aspects may be used when depth of field recordings are essential. Cameras capable of recording thermal fields may be used when heat measurements must be recorded.

Preferably, the RVS units 20 are monitored by the software operated by the computer processor 40. In a preferred embodiment, this is performed using a laptop or desktop computer. Optionally, any machine 40 having a processor capable of running the software may operate at least one RVS unit 20 or at least one DRPS unit 30. Alternatively, any machine 40 having a processor capable of running the software may operate both the RVS unit 20 and DRPS unit 30.

Once video data is transmitted to the DRPS 30 from the RVS unit 20, at least one user of the system can access video data from the DRPS unit 30. In a preferred embodiment, a user may access the DRPS unit 30 wirelessly. A plurality of users may access video data from the DRPS unit 30 simultaneously via a wireless connection without affecting the performance or quality of the video data playback.

A RVS power source 21 supplies power to the RVS unit 20, and a DRPS power source 31 supplies power to the DPRS unit 30. Preferably, the power source 21 and 31 has sufficient capacity to power as a dedicated source for proper functioning of either the RVS unit 20 or DRPS unit 30. Optionally, the power source 21 and 31 may be rechargeable. Most preferably, the power source 21 and 31 is a battery. Alternatively, the power source 21 and 31 may be a standard wall socket.

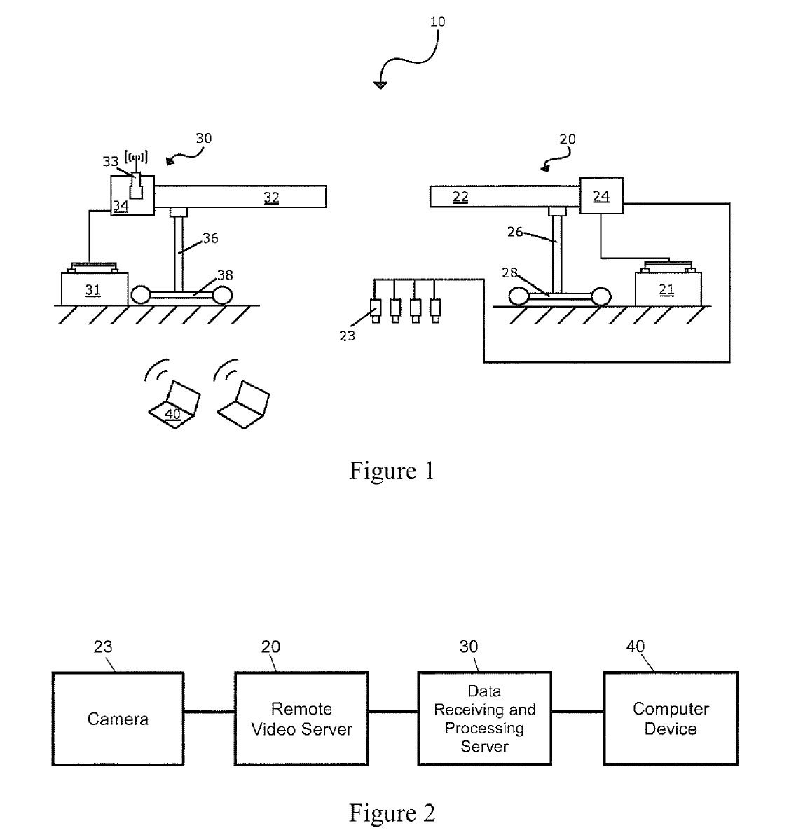

FIG. 2 is a block diagram that generally depicts the flow of video data through the portable surveillance system 10. The camera 23 captures video data and transmits said video to the RVS unit 20. The RVS unit 20 wirelessly transmits the video data to the DRPS unit 30 for processing. A computer device 40 may wirelessly connect to the DRPS unit 30 to view the video data. The connection between the DRPS unit 30 and the computer device 40 is encrypted and is secure against undesired connections. Multiple users may use another computer device 40 to view the video data without substantial quality degradation.

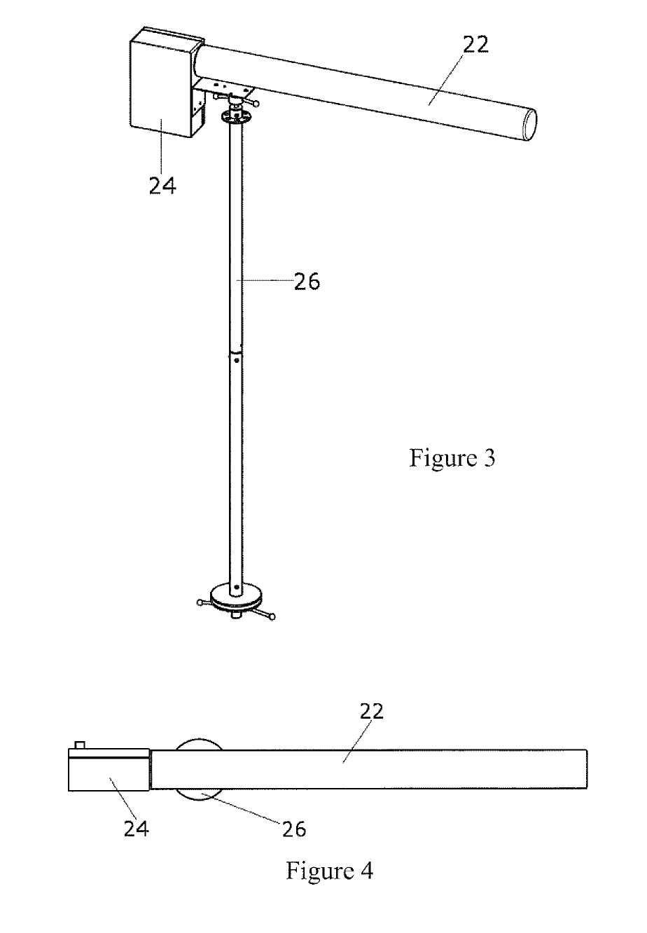

FIG. 3 depicts a perspective view of a RVS unit 20, and FIG. 4 depicts a top plan view of the RVS unit 20. The RVS unit 20 is capable of transmitting data to the DRPS unit 30 from a distance of up to several miles. Each unit is comprised of two pieces: an RVS server 24 and an RVS rod 22 for transmission of data between units. In a preferred embodiment, the relationship between RVS server 24 and RVS rod 22 is perpendicular. Alternatively, the RVS server 24 may be positioned in parallel to the RVS rod 22. The RVS server 24 and the RVS rod 22 are supported vertically by being attached to a RVS stand 26.

Moreover, the RVS unit 20 and DRPS unit 30 are substantially similar in structure. The DRPS unit 30 has a substantially similar DRPS stand 36, DRPS server 34 and DRPS rod 32. In a preferred embodiment, the relationship between DRPS server 34 and DRPS rod 32 is perpendicular. Alternatively, the DRPS server 34 may be positioned in parallel to the DRPS rod 32. The DRPS server 34 and the DRPS rod 32 are supported vertically by being attached to a DRPS stand 36. While substantially similar, the DRPS unit 30 has an antenna 33 to facilitate transmissions between the DRPS unit 30 and the computer device 40.

For optimal signal strength, the RVS rod 22 is positioned in the general direction of the DRPS unit 30, and the DRPS rod 32 is positioned in the general direction of the RVS unit 20. The connection between the RVS unit 20 and the DRPS unit 30 may still function even if the units are not facing each other directly. The DRPS server 34 processes the video data for proper transmission to the computer device 40. Such processing includes, but is not limited to, compression, optimization, deinterlacing, denoising, deblocking, deringing and deflicking.

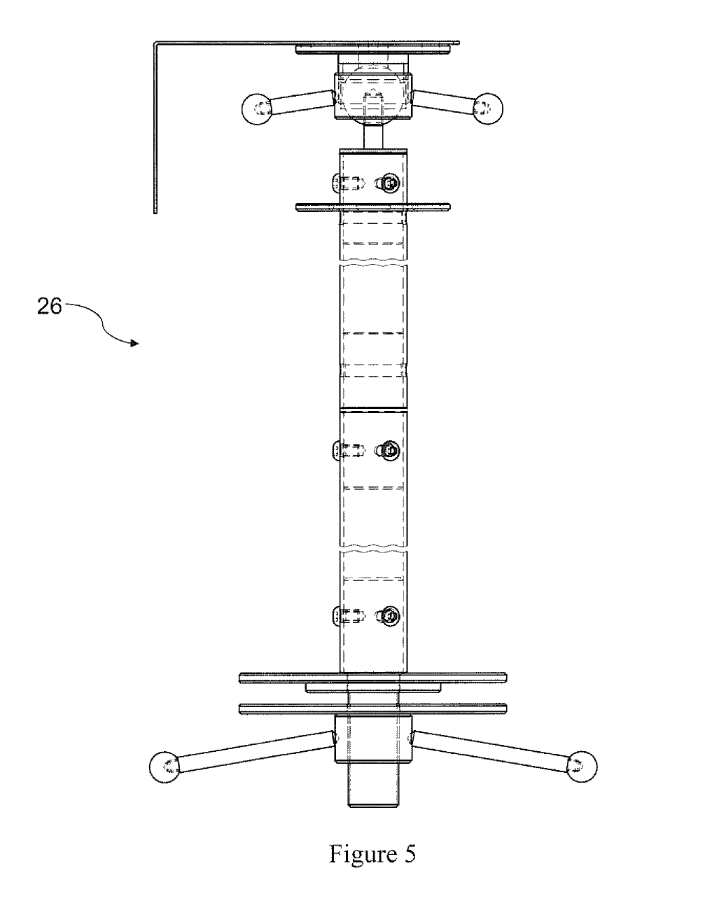

With regard to FIG. 5, a more detailed view of the RVS stand 26 supporting the RVS unit 20 is illustrated. As is indicated, it is clear that each stand is divided into several subunits, which provide the structural support and mobility of each unit. The DRPS stand 36 is substantially similar to the RVS stand 26. The DRPS stand 36 and the RVS stand 26 are interchangeable with each other.

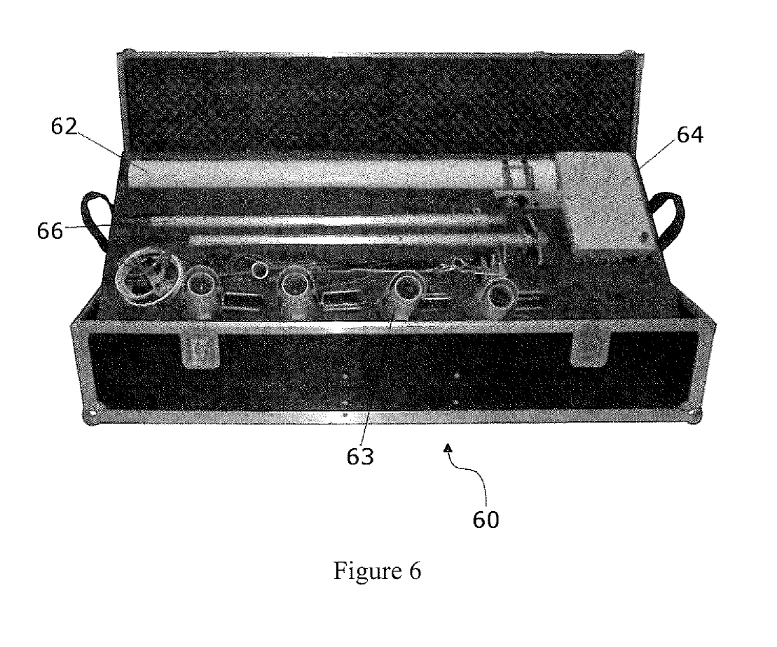

With regard to FIG. 6, a remote surveillance kit 60 is depicted in a perspective view. The remote surveillance kit 60 as shown has a server 64, a rod for transmitting video data 62, a stand 66 designed to support the server 64 and the rod 62 and a camera 63. The server 64 may be configured to be either a RVS or a DRPS depending on whether the camera 63 or an antenna 65 is attached. If the server is configured to be an RVS, the rod 62 will be configured to transmit video data to a corresponding DRPS. If the server is configured to be a DRPS, the rod 62 will be configured to receive video data from a corresponding RVS. The server 64 will then process the video data with processing including, but is not limited to, compression, optimization, deinterlacing, denoising, deblocking, deringing and deflicking. With an attached antenna, a computer device 40 may log in to the server 64 and view the video data.

While the particular invention as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A method for providing remote surveillance to a target area, the method comprising:
providing a remote video server portably to the target area;
providing a camera in surveillance of the target area;
transmitting video data to a portable data receiving and processing server;
processing said video data; and
accessing the video data locally or remotely on a computer device.

2. The method for providing remote surveillance to a target area of claim 1, wherein the target area is a construction site.

3. The method for providing remote surveillance to a target area of claim 1, wherein the target area is a remote rural area.

4. The method for providing remote surveillance to a target area of claim 1, wherein the remote video server is controlled by a computer device accessed locally or remotely by a user.

5. The method for providing remote surveillance to a target area of claim 1, wherein the camera transmits the video data to the remote video server.

6. The method for providing remote surveillance to a target area of claim 5, wherein the remote video server transmits the video data to the data receiving and processing server.

7. The method for providing remote surveillance to a target area of claim 1, wherein the data receiving and processing server processes the video data.

8. A system for providing remote surveillance to a target area, the system comprising:
a remote video server placed in the target area;
a camera in surveillance of the target area capturing video data;
a portable data receiving and processing server configured to receive video data; and
a computer device configured to communicate with the data receiving and processing server.

9. The system for providing remote surveillance to a target area of claim 8, wherein the remote video server is movably placed in the target area and is not rigidly fixed to a particular location.

10. The system for providing remote surveillance to a target area of claim 8, wherein the camera transmits video data to the remote video server.

11. The system for providing remote surveillance to a target area of claim 8, wherein the camera is activated by detecting motion.

12. The system for providing remote surveillance to a target area of claim 8, wherein the camera is selected from the group consisting of a standard video camera, a high definition camera, an infrared camera, a thermal camera and a 3D camera.

13. The system for providing remote surveillance to a target area of claim 10, wherein the remote video server transmits the video data to the data receiving and processing server.

14. The system for providing remote surveillance to a target area of claim 13, wherein the data receiving and processing server processes the video data

15. The system for providing remote surveillance to a target area of claim 8, wherein the computer device is wirelessly connected to the data receiving and processing server.

16. A remote surveillance kit, comprising:
a server;
a rod configured for transmitting video data; and
a stand configured to support the server and the rod.

17. The remote surveillance kit of claim 16, further comprising camera configured to capture video data.

18. The remote surveillance kit of claim 17, wherein the camera transmits the video data to the server, and the video data is broadcast via the rod.

19. The remote surveillance kit of claim 16, wherein the server receives and processes video data from an external source via the rod.

20. The remote surveillance kit of claim 19, further comprising an antenna for communicating with a computer device.
